(19) United States
(12) Patent Application Publication
(10) Pub. No.: US 2015/0290542 A1
(43) Pub. Date: Oct. 15, 2015

(54) DEVICE, GAME AND AUTOMATIC CONTROL METHODS THEREFOR

(71) Applicant: KING.COM LIMITED, St. Julians (MT)

(72) Inventor: Klas Norden, Stockholm (SE)

(73) Assignee: KING.COM LIMITED, St. Julians (MT)

(21) Appl. No.: 14/252,074

(22) Filed: Apr. 14, 2014

(51) Int. Cl. A63F 13/573

(52) U.S. Cl. CPC A63F 13/573

(57) ABSTRACT

In an embodiment there is provided a device having a user interface configured to display a game board having a plurality of game objects, each game object having one or more characteristics stored in at least one memory, said user interface being configured to receive user input, and at least one processor in connection or communication with the at least one memory and the user interface and configured to display a game area having a plurality of game objects, each having at least one or more characteristics, provide a user object configured to target and release a user projectile associated with said user object at said game objects in response to user input, determine a return trajectory of said projectile once released, and automatically reposition said user object on the displayed game board in response to said determined return trajectory to associate said user object with the returning projectile. A method, computer program and computer program product are also described.

### FIELD OF THE INVENTION

Some embodiments may relate to controlling a user interface responsive to user engagement with displayed game objects on the interface of a computer device.

Some embodiments may relate to devices having a user interface for engaging users or players in a computer game executable in an online environment.

### BACKGROUND OF THE INVENTION

There are many technical challenges and technical considerations facing the designer of computer games executed on user or computer devices having a user interface, such as designing a controllable user interface in the context of available computer devices and resources, which may be limited.

Another technical challenge can involve enabling a game to be fun, accessible and compelling even when there is limited display resource available, such as when a game is being played on a smartphone, tablet or other small or portable device.

Another challenge lies in providing reliable control and input across many architectures of such devices with limited or differing display, processing and touch input resources.

This is pertinent when considering user engagement. Engagement involves designing gameplay to be engaging and rewarding to players. This typically requires games to be easily understood at their simplest or introductory levels, control inputs should provide rewarding gameplay with simple to complex game mechanics, which may become progressively more challenging so that players are not frustrated or bored, but remain engaged to develop rewarding skills.

Effective engagement may also require various forms of feedback to reinforce the user or player sense of success and accomplishment.

There are therefore many technical challenges when designing computer implemented games, particularly in providing a challenge to a user or player that is engaging and rewarding so as to provoke repeat play. This may, but not exclusively apply to “casual games” played on portable or mobile platforms with differing and in some cases limited computing, display and input resources.

### SUMMARY OF THE INVENTION

According to an aspect, there is provided a computer implemented method of controlling a user interface responsive to user engagement with a displayed game board on said interface, the method comprising the following implemented by at least one processor of a computer device in communication with said interface and at least one memory: displaying a game area having a plurality of game objects, each having at least one or more characteristics, providing a user object configured to target and release a user projectile associated with said user object at said game objects in response to user input, and determining a return trajectory of said projectile once released, and automatically repositioning said user object on the displayed game board in response to said calculated return trajectory to associate said user object with the returning projectile.

The determination of said return trajectory may be dependent on the detection of a collision of the projectile with at least one game object.

The determination of said return trajectory may be dependent on the detection of more than one collision of the projectile with at least one first or second or further game object.

At least one first game object sharing at least one characteristic with one or more of the plurality of game objects may be generated for display.

The first game object may be graphically represented on the display as a pupa.

A second or further game object sharing at least one characteristic with one or more of the plurality of game objects in response to at least one detected collision of said projectile with the at least one first game object may be generated.

The second or further game object may be graphically represented as a butterfly.

Detection of a collision of said projectile with said second or further game object may eliminate those displayed game objects sharing the at least one characteristic of said second or further game object.

The determination of said return trajectory may be dependent on the elimination of said displayed game objects.

The determination of said return trajectory may be further modified in dependence on the angle of incidence of said projectile with respect to said game board upon detection of said collision of the projectile with the at least one game object.

The determination of said return trajectory may comprise calculating an angle of reflection in dependence on the angle of incidence.

The angle of reflection may be calculated at least in part in proportion to the angle of incidence.

The angle of reflection may be adjusted by a random number in proportion to the angle of incidence.

The determined return trajectory may be further modified in dependence on said random number adjustment.

In another embodiment, the determined return trajectory of the at least one projectile may comprise the automatic repositioning of the user object in order to associate the user object with the returning projectile.

In yet another embodiment, the automatic repositioning may be determined when the at least one processor computes that the projectile trajectory has crossed or will cross or coincide with a user object regional indicator. It should be noted that the nominal user object indicating region may be displayed to a user in some embodiments, but in other embodiments the region will not usually be displayed to the user on the game board or area.

The characteristics of the game objects may comprise the game objects being coloured, and may further comprise that game objects be distinguished or matched to other game objects by being coloured differently or sharing the same colour.

The varying characteristics of the game objects may comprise the game objects being represented graphically on the user interface as coloured bricks.

The first game object may be graphically represented as a pupa.

The pupa may share one or more characteristics with at least one of the game objects.

At least one of the shared characteristics of the pupa may be colour.

The determination of a collision of the user projectile with the first game object may eliminate the first game object and generate display of at least one second or further game object.

The at least one second or further game object may share at least one or more characteristics of said new game object on said game board.

The second or further game object may be graphically represented as a butterfly.

The butterfly may share one or more characteristics with at least one of the game objects.

At least one of the shared characteristics of the butterfly may be colour.

The second or further game object may share a characteristic of the first game object.

The determination of a collision of the user projectile with said second or further game object may eliminate said second or further game object and all other game objects sharing at least one of the one or more characteristics of said second or further game object on said game board.

According to another aspect there is provided a device having a user interface configured to display a game board having a plurality of game objects, each game object having one or more characteristics stored in at least one memory, said user interface being configured to receive user input, and at least one processor in connection or communication with the at least one memory and the user interface and configured to: display a game area having a plurality of game objects, each having at least one or more characteristics, provide a user object configured to target and release a user projectile associated with said user object at said game objects in response to user input, determine a return trajectory of said projectile once released, and automatically reposition said user object on the displayed game board in response to said determined return trajectory to associate said user object with the returning projectile.

The at least one memory may store one or more characteristics of one or more game objects, first game objects and second or further game objects for generation and display by said processor.

The one or more characteristics may comprise at least one of: displayed colour, object type, collision behaviour.

The at least one stored collision behaviour may comprise eliminating game objects sharing the same at least one characteristic.

According to yet another aspect there is provided a program comprising program code instructions that, when executed by a processor, causes said processor to perform the following steps: displaying a game area having a plurality of game objects, each having at least one or more characteristics, providing a user object configured to target and release a user projectile associated with said user object at said game objects in response to user input, determining a return trajectory of said projectile once released, and automatically repositioning said user object on the displayed game board in response to said determined return trajectory to associate said user object with the returning projectile.

According to another aspect there is provided a computer readable storage device storing instructions that, when executed by a processor, causes said processor to perform the following steps: displaying a game area having a plurality of game objects, each having at least one or more characteristics, providing a user object configured to target and release a user projectile associated with said user object at said game objects in response to user input, determining a return trajectory of said projectile once released, and automatically repositioning said user object on the displayed game board in response to said determined return trajectory to associate said user object with the returning projectile.

According to another aspect there is provided a device comprising means configured to display a game board having a plurality of game objects, means for receiving user input, means for storing one or more characteristics of said game objects, the means for storing being connected by communication means to processing means configured to: display on said display means a game area having a plurality of game objects, each game object having at least one or more characteristics stored in said means for storing, provide a user object configured to target and release a user projectile associated with said user object at said game objects in response to user input from said input means, determine a return trajectory of said projectile once released, and automatically reposition said user object on the displayed game board in response to said determined return trajectory to associate said user object with the returning projectile.

The means for storing may store one or more characteristics of one or more game objects, first game objects and second or further game objects for generation and display by said display means via said processing means.

The one or more characteristics may comprise at least one of: displayed colour, object type, collision behaviour.

The at least one stored collision behaviour may comprise eliminating game objects sharing the same at least one characteristic.

The display means may comprise user interface means.

The user interface means may comprise the input means.

The input means may comprise touch control means.

The touch control means may comprise capacitive, resistive or gesture detecting means.

The processing means may control said display means to eliminate said second or further game object from the displayed game board in response to received user input of said input means, said received input comprising a determination of a collision of the projectile with said further game object.

The processing means may control said user interface means to eliminate said second or further game object and all other game objects having at least one same characteristic as said second or further game object from the displayed game board in response to a determination of a collision of the projectile with said second or further game object.

### BRIEF DESCRIPTION OF DRAWINGS

To understand some embodiments, reference will now be made by way of example only to the accompanying drawings, in which:

FIG. 1 shows an example embodiment of a game board;

FIG. 2 shows an example user device in which some embodiments may be provided;

FIG. 3 shows an example system in which some embodiments may be provided;

FIGS. 4a, 4b, 4c, 4d and 4e show example projectile behavior and trajectory prediction according to some embodiments;

FIG. 5 illustrates a game board having second or further game objects according to some embodiments;

FIG. 6 depicts an example second or further game object behavior according to an embodiment;

FIG. 7 shows an alternative game board according to an embodiment;

FIG. 8 is a flowchart depicting steps of a method according to an embodiment.

### DETAILED DESCRIPTION OF SOME EMBODIMENTS

The techniques described herein can be implemented in for instance a computer game which involves the targeting and shooting of game objects and the elimination of such to complete a level or aim or target of such a game. The game may be a so-called “casual” or “social” game, wherein short periods of play are undertaken by the user whenever appropriate according to the user's schedule.

Such games are increasingly offered and played by users on portable devices so as to fit in with the user's lifestyle and schedule. Such portable devices may have limited resources in terms of display screen size (“screen real-estate”), processing power and may be powered ostensibly by battery only thereby leading to a potentially short battery-life trade-off with use. Furthermore, the screen real-estate of such devices such as mobile phones, may be limited. When such a screen is a so-called “touchscreen”, then the limited dimensions and sensitivity of the touchscreen may lead to control and input issues due to the limited resources available. Such issues may all too often lead to user frustration when using the device, and especially when using the device in the context of playing a game with an objective and which may provide prizes or social data.

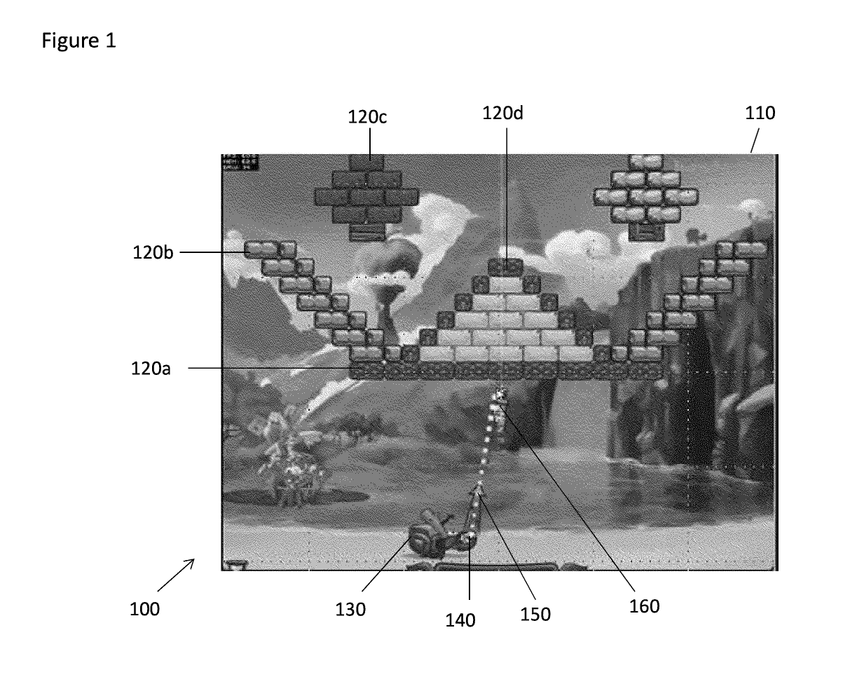

FIG. 1 shows an example game board for display on a user device according to an embodiment. The game has a game board 100 with a playable area 100 upon which are disposed game objects 120a, 120b, 120c, 120d which may have varying characteristics. The characteristics may be one or more of colour, shape, and/or different types of objects. In this embodiment, the objects are differently coloured graphical representations of block or brick shaped objects.

The game objects may take other graphical representations and shapes, and may represent different types of similar objects when displayed on the game area 110.

In some embodiments, the game may be implemented so that a level or a game session is completed when all or designated game objects 120a, 120b, 120c, 120d on the game board 100 have been cleared or eliminated.

Game objects 120a, 120b, 120c, 120d may be removed from the game board 100 by targeting or aiming and releasing or shooting a provided projectile 140 from a user controlled user object 130 towards said game objects 120a, 120b, 120c, 120d to effect a collision, according to for example touch input to aim and release the projectile 140.

One or more first game objects 160 may then be generated and displayed on the game board 100 in dependence on predefined generation rules. For example, the removal of several game objects 120a of the same characteristic 120a in consecutive “shots” may trigger the generation of the one or more first game object 160. In other embodiments the generation of the one or more first game object or objects may be randomly influenced.

The user or player may in some embodiments be rewarded for good gameplay. For instance a series of consecutive targeting of neighbouring game objects sharing at least one of the one or more data characteristics may increase a bonus multiplier.

The game may, in one embodiment, end if the player or user runs out of time or moves or shots before managing to reach a designated target (not shown in FIG. 1).

The game board 100 may have a plurality of game objects 120a, 120b, 120c, 120d having different characteristics aligned in rows and columns or forming patterns on the game board 100 as shown in FIG. 1. Other grid sizes or patterns may be suitable.

The game objects 120a, 120b, 120c, 120d on the game board 100 may have six (or any other suitable number of) contact points with other neighbouring or adjacent game objects.

Other game board layouts or configurations may be provided. For example, pyramidal, hexagonal, octagonal or other layouts comprising position spaces or tiles within the game board 100 may be provided for display.

In some embodiments the game objects 120a, 120b, 120c, 120d may be depicted as blocks or brick of differing colours. The number of differing colours may for example be three or more colours.

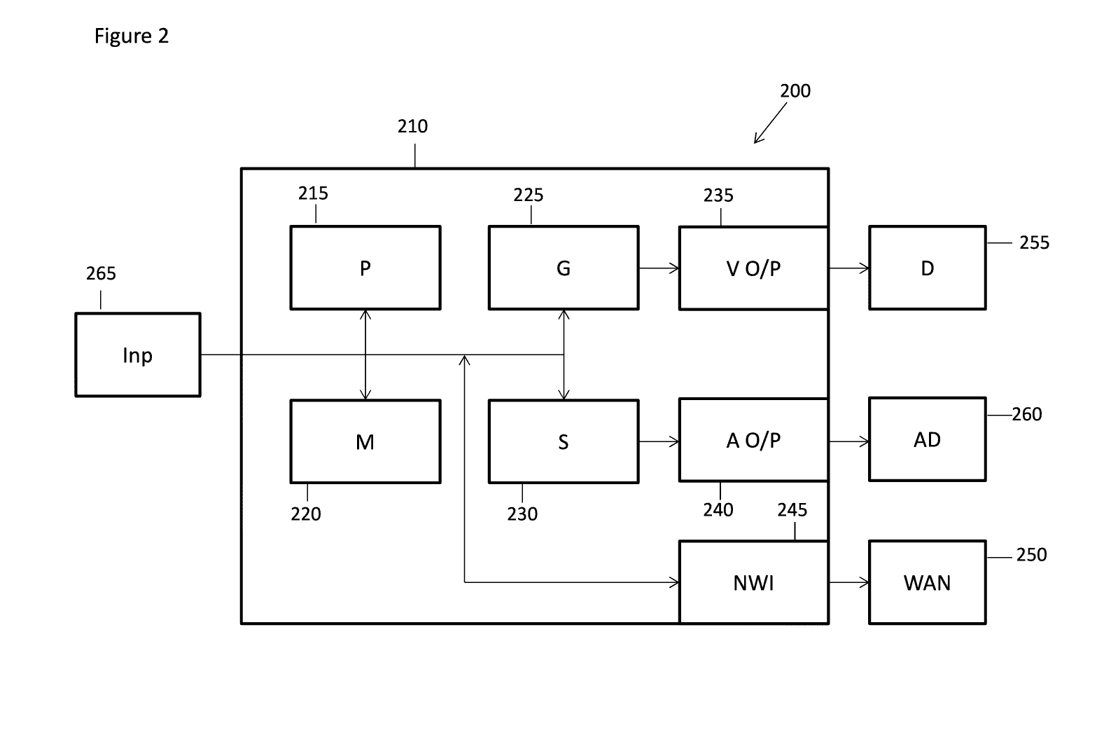

A schematic view of a user or computing device 200 according to an embodiment is shown in FIG. 2. All of the blocks shown are implemented by suitable circuitry. The blocks may be implemented in hardware and/or software. The user device may have a control part 210. The control part 210 has one or more processors 215 and one or more memories 220. The control part 210 is also shown as having a graphics controller 225 and a sound controller 230. It should be appreciated that one or other or both of the graphics controller 225 and sound controller 230 may be provided by the one or more processors 215.

The graphics controller 225 is configured to provide a video output 235. The sound controller 230 is configured to provide an audio output 240. The controller 210 has an interface 245 allowing the device to be able to communicate with a network 250 such as the Internet or other communication infrastructure.

The video output 235 is provided to a display 255. The audio output 240 is provided to an audio device 260 such as a speaker and/or earphone(s).

The device 200 has an input device 265. The input device 265 can take any suitable format and can be one or more of a keyboard, mouse, touch screen, joystick or game controller. It should be appreciated that the display 255 may in some embodiments also provide the input device 265 by way of an integrated touch screen for example.

The blocks of the controller 210 are configured to communicate with each other by an interconnect such as a bus or any other suitable interconnect and/or by point to point communication.

It should be appreciated that in some embodiments, the controller 210 may be implemented by one or more integrated circuits, at least in part.

The user device 200 is shown by way of example only. In alternative embodiments, one or more of the parts may be omitted. Alternatively or additionally, some embodiments may comprise one or more other parts. Alternatively or additionally, one or more parts may be combined.

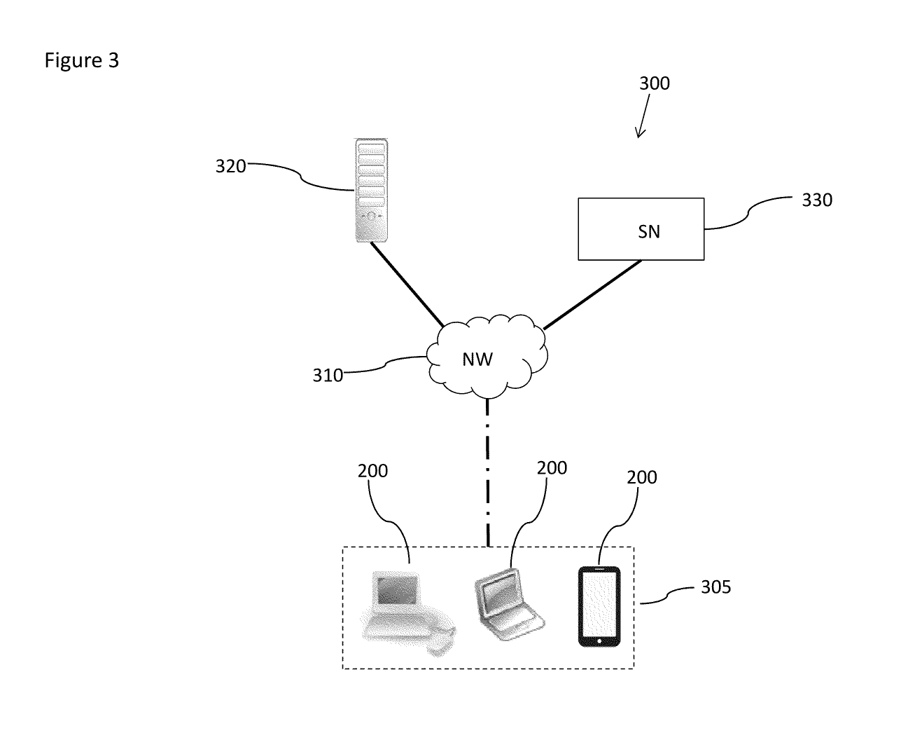

FIG. 3 schematically shows a system 300 in some embodiments. The system 300 comprises a server 320 which may store databases of game players' details, profiles, high scores and so on. In practice, one or more databases may be provided. Where more than one server is provided, the database(s) may be provided in one database or across two or more servers 320. The server 320 may also have a games data function. This may comprise a memory to store the computer game program and a processor to run the games program.

The server may communicate via for instance the internet 310 to one or more user devices 305 and may further provide connections to a social network 330 such as facebook™.

It should be appreciated that embodiments may be deployed in different system architectures. For example, the computer game may be implemented as a computer game that is stored in the memory 220 of the user device 200 and is run on the processor 215 of the user device 200. However, the server 320 may handle some elements of the game in some embodiments. By way of example only, a Java game applet may be provided to the user device 200 and the locally running Java applet will generate, for example, the graphics, sounds, and user interaction for the game play on the user device 200. Some data may be fed back to the server 320 to allow interaction with other players 305. The data which is fed back may also allow scoring and/or cross platform synchronization.

In some embodiments, the game may be implemented as a computer program that is stored in a memory of the system, for example the server 320, and which runs on a processor of the game server. Data streams or updates are supplied to the user device 200 to allow the user device 200 to render and display graphics and sounds in a browser of the user device 200. Such an approach is sometimes referred to as a web services approach. It should be appreciated, however, that such an approach does not necessarily require the use of the Internet.

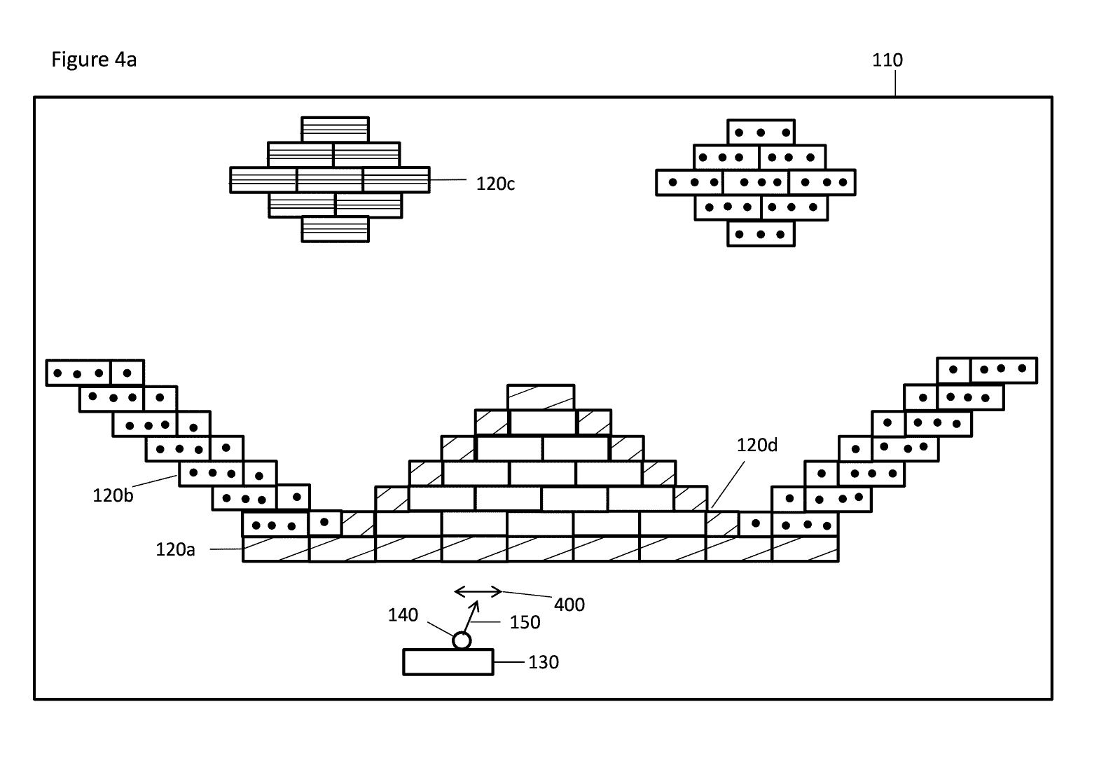

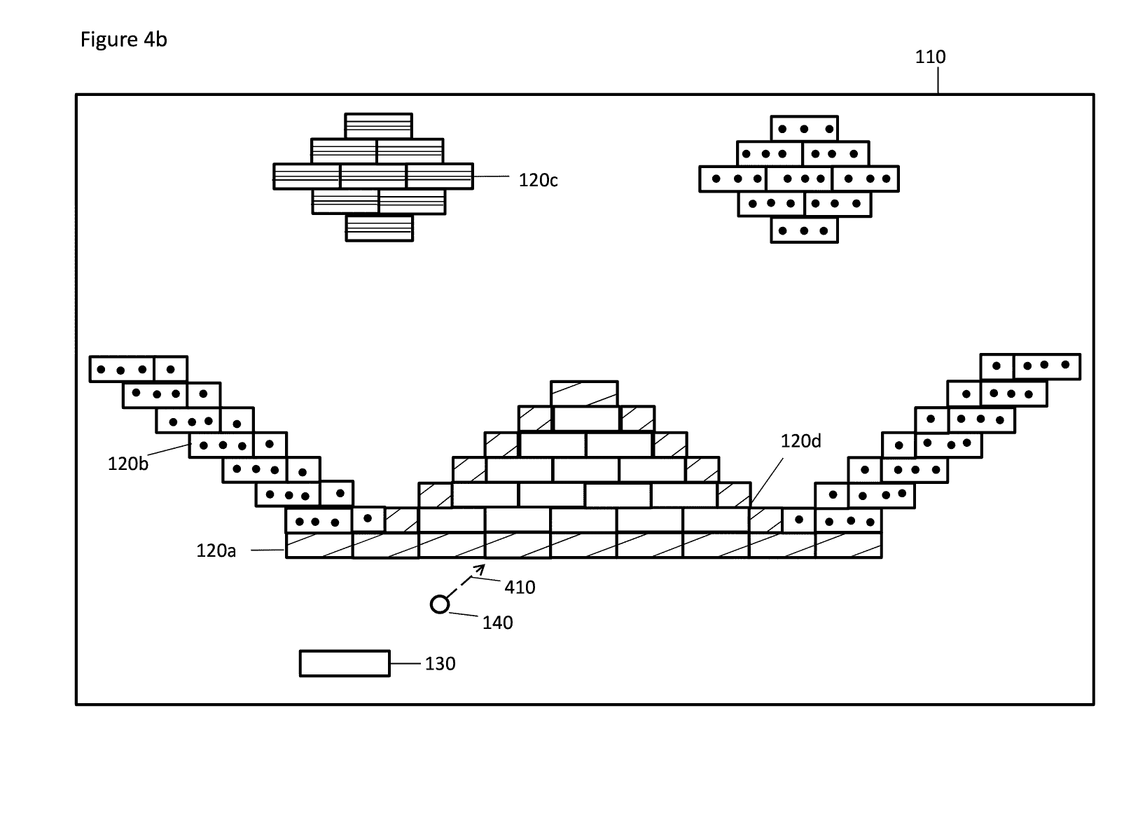

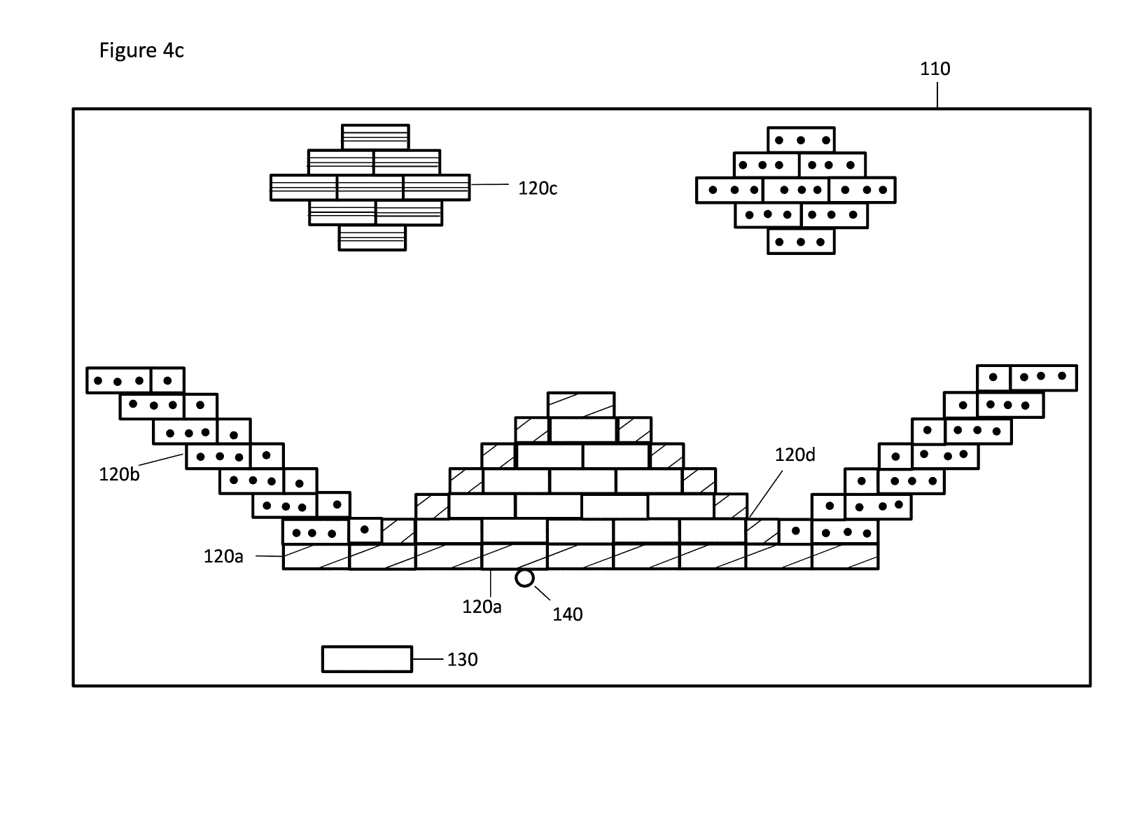

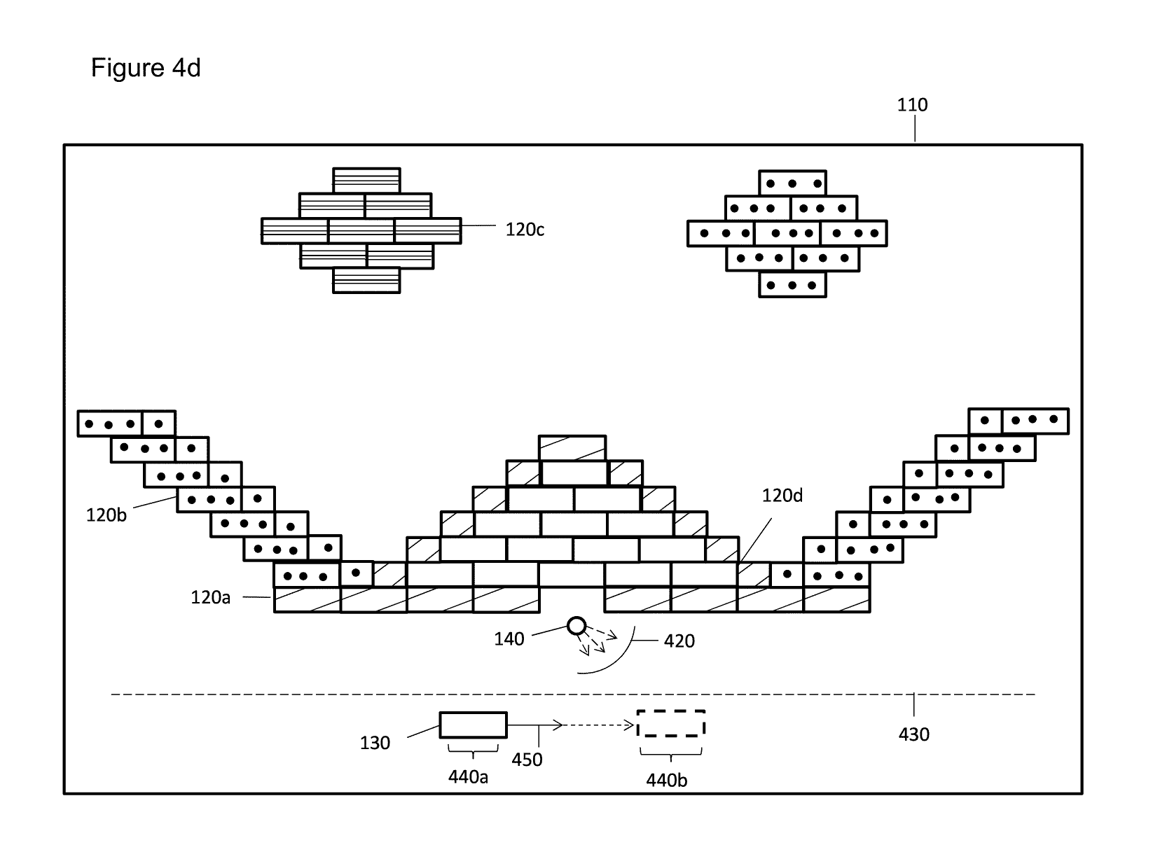

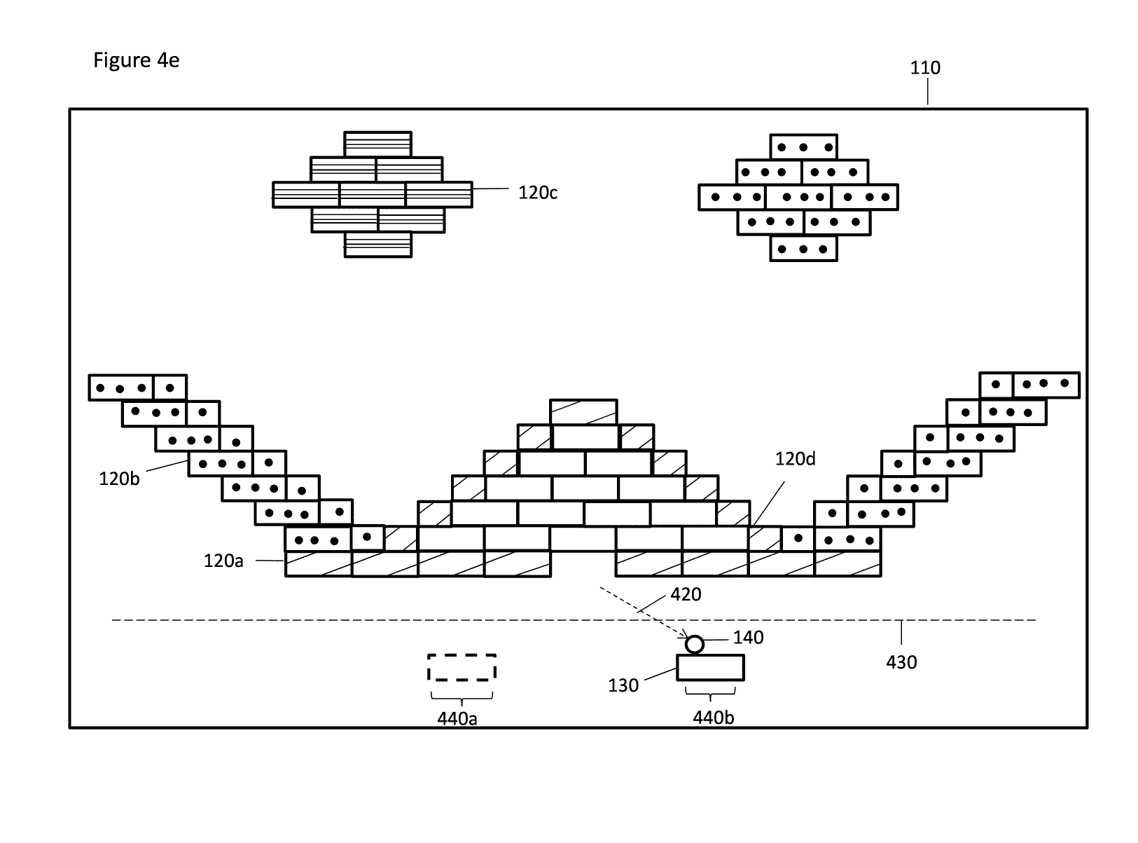

Embodiments will now be described with reference to FIGS. 4a, 4b, 4c, 4d, and 4e.

FIG. 4a shows a schematic representation corresponding to the game board 100 and game area 110 of FIG. 1. The game area 110 comprises a pattern or layout of displayed game objects 120a, 120b, 120c, 120d on display 255, the game objects having at least one or more characteristics. The depiction of shading of the user objects 120a, 120b, 120c, 120d in FIG. 4a indicates that the user objects have differing characteristics such as colours or shades.

Also shown in FIG. 4a is a representation of the user object 130, which is disposed with a user projectile 140. Also provided, is a targeting or aiming indicator 150, in this example an arrow indicating the outward bound trajectory of the projectile 140 should it be released in the direction indicated by the targeting or aiming indicator 150. The target indicator 150 may be manipulated in order to target at least one of the game objects 120a, 120b, 120c, 120d via user input either by mouse 265, keyboard 265, or a touch user interface 255, 265 of a user device 200, 305 as previously described with references to FIGS. 2 and 3. The user input 265 may be used to vary the aim 400 of the projectile 140. A user may therefore selectively target the projectile 140 at particular game objects 120a, 120b, 120c, 120d as desired.

FIG. 4b schematically illustrates the game area 110 of FIG. 4a after the user has targeted and released projectile 140 via said input means 265 or touch user interface 255,265. As shown in the Figure, the projectile 140 follows an outward trajectory 410 as indicated by arrow 410 on the figure. The trajectory 410 was previously selected by the user 400 when aiming and releasing the projectile 140.

FIG. 4c illustrates an example situation following on from FIG. 4b, wherein the projectile 140 has reached game object 120a on the game area 110 as shown in the figure. That is, the projectile 140 may collide with game object 120a.

Other inputs 400 may result in other aim directions 410 of the projectile 140, and subsequent collision of said projectile 140 with varying game objects 120a, 120b, 120c, 120d having one or more characteristics.

FIG. 4d illustrates a potential situation subsequent to the collision of projectile 140 with game objects 120a, 120b, 120c, 120d as shown in FIG. 4c. FIG. 4d shows the projectile 140 now following a return trajectory 420 after colliding with game object 120a, 120b, 120c, 120d which has been eliminated from the game area 110 as shown in the Figure. The user object 130 was displayed in a first position 440a as shown in the figure when the projectile was released (see FIG. 4b). The processor 215 or server 320, or a combination of each depending on the particular user device 305, 200 and the environment or network 310, 330 being used determines the initial or first position 440a of the user object 130.

Also shown in FIG. 4d is the future or second position 440b, determined by the at least one processor 215, 320 in dependence on the return trajectory 420 of the projectile 140. FIG. 4d also indicates an optional dashed line 430 (not displayed to the user) which represents a nominal user object region below which the first 440a and second 440b positions may be determined in some embodiments.

In another embodiment the positions of the user object determined in dependence on the return trajectory 420 of the projectile 140 may be calculated solely based on the indicated return trajectory 420 and the calculation modified in dependence on a random or pseudo random generated number. This may advantageously, in an embodiment, provide non-expected behaviour of the projectile 140 thereby engaging or surprising the user.

In another embodiment, the determination of the automatic repositioning of user object 130 in order to associate the user object with the returning projectile 140 may be determined when the at least one processor 215 computes that the projectile 140 has passed the user object regional indicator 430. It should be noted that the nominal user object 130 indicating region 430 is an optional feature and in embodiments may be, but in other embodiments will not usually be, displayed to the user on the game area 110.

FIG. 4e shows the game area 110 of the previous FIG. 4c, wherein the user object 130 has been automatically repositioned from the first position 440a to a second position 440b in dependence on the determined return trajectory 420 in order to coincide or “catch” the user projectile 140.

Hence, the user object 130 may effectively be automatically repositioned to “catch” the projectile 140, thereby relieving the user of complicated and sporadic input problems on devices with limited resources such as small displays, and or suffering from inadequate game area for sensible input.

Hence in some embodiments, the automatic repositioning 440a, 440b of the user object 130 to catch or coincide with the projectile 140 once released provides an enhanced engaging experience in which the user is free to concentrate on the game object by aiming 410 the projectile 140 selectively during a level.

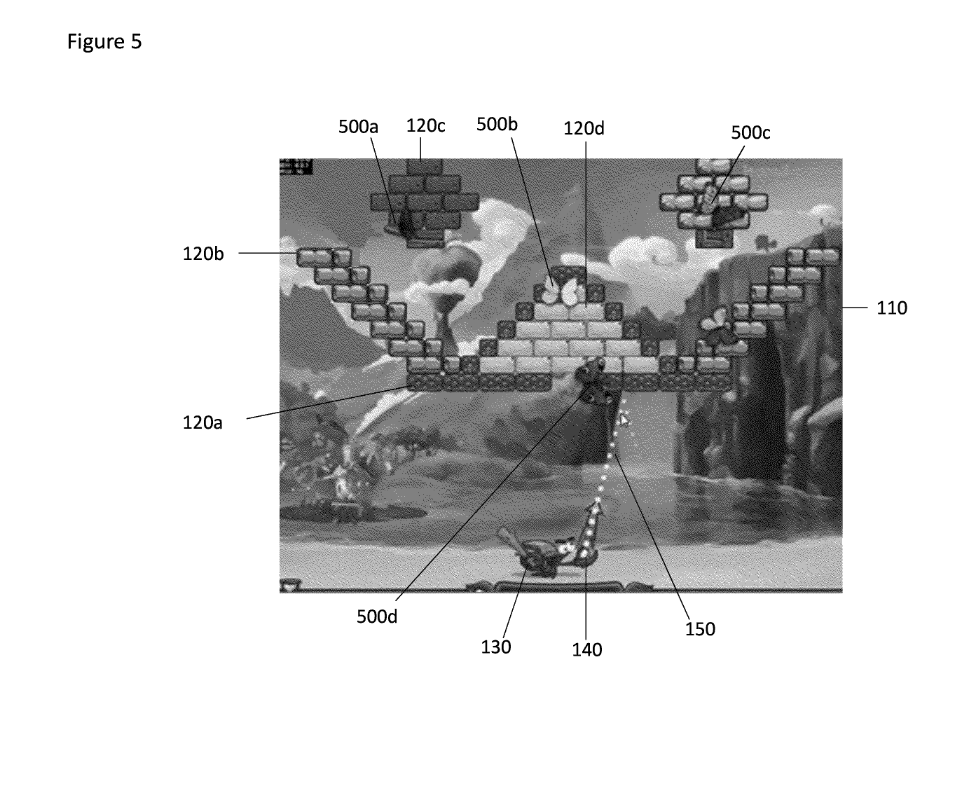

Further advantageous embodiments will now be expounded upon with reference to FIG. 5, which shows a game area 110 similar to that of FIG. 1. A first game object in the form of a graphical coloured pupa 160 of FIG. 1 has been successfully targeted and hit by projectile 140, that is a collision has been detected by said processor 215 or server 320 of the projectile 140 with said first game object 160. In this embodiment the processor 215, on detecting a collision of the projectile 140 with the first game object 160 subsequently creates a second or further game object or objects 500a, 500b, 500c and generates these for display 255 on the game area 110.

In this embodiment the second or further game objects 500a, 500b, 500c are depicted in the form of a graphical representation of a butterfly, sharing at least one characteristic with one or more of the user objects 120a, 120b, 120c, 120d. For example, as shown in FIG. 5, the second or further game object 500b has at least one characteristic (colour) shared with one or more of the plurality of game objects 120d. In some embodiments, one further game object is created for each of the different characteristics.

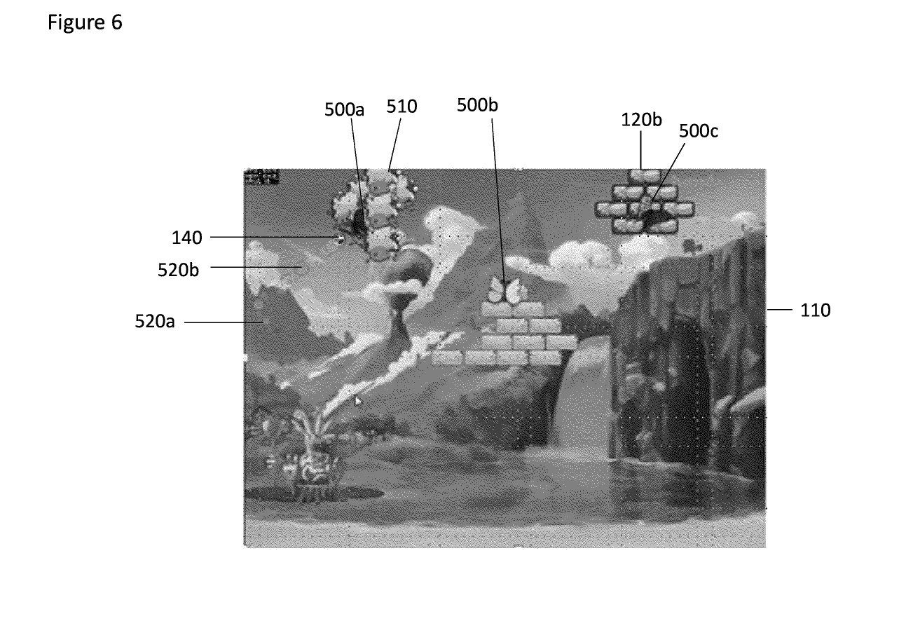

FIG. 6 illustrates an example situation when a collision of projectile 140 with the second or further game object 500 is detected by processor 215. FIG. 6 shows an outbound trajectory 520a of projectile 140, the trajectory then deflecting or “bouncing” off the border of the game area 110 in order to bring the projectile into collision 510 with the second or further game object 500a.

The collision 510 of projectile 140 with the second or further game object 500a, is detected by processor 215 which subsequently proceeds to eliminate all game objects 120a, 120b, 120c, 120d sharing at least one same characteristic (in this instance colour) with the second or further game object 500a. Therefore the targeting of first game objects 160, leading to the creation of second or further game objects 500a, 500b, 500c provides a game mechanic enabling skilful and fast elimination of game objects 120a, 120b, 120c, 120d in order to achieve or complete a level of the game.

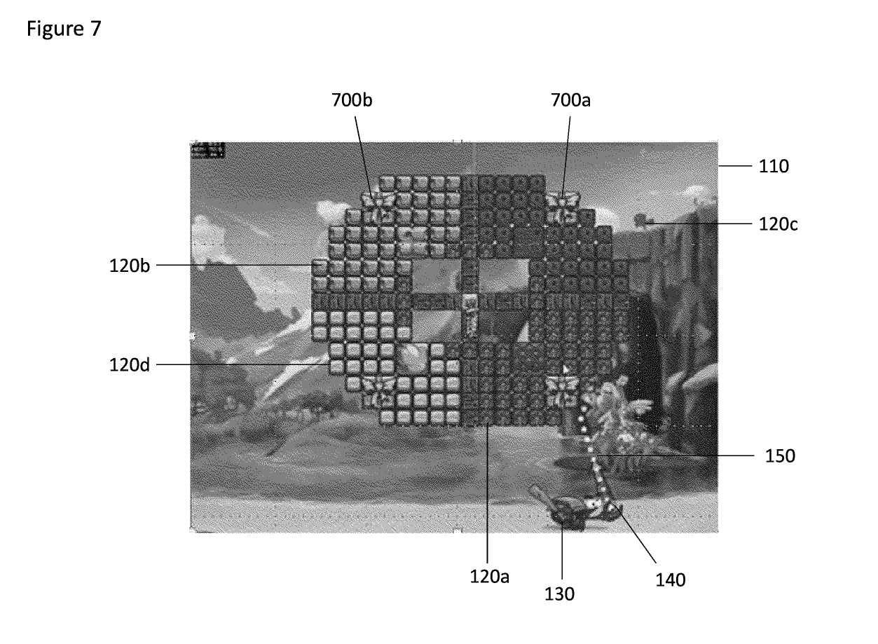

FIG. 7 shows an embodiment of a game area 110 showing a different layout of game objects 120a, 120b, 120c, 120d. Also shown in the diagram are game objects 700a, 700b which may also be generated in order to enhance gameplay and provide a more rewarding and engaging experience. The game objects 700a, 700b may upon detection of a collision of the user projectile 140 with said game objects 700a, 700b reveal a first 160 or second or further 500a, 500b, 500c game object as previously described, or may produce booster or other game elements or objects in order to enhance gameplay.

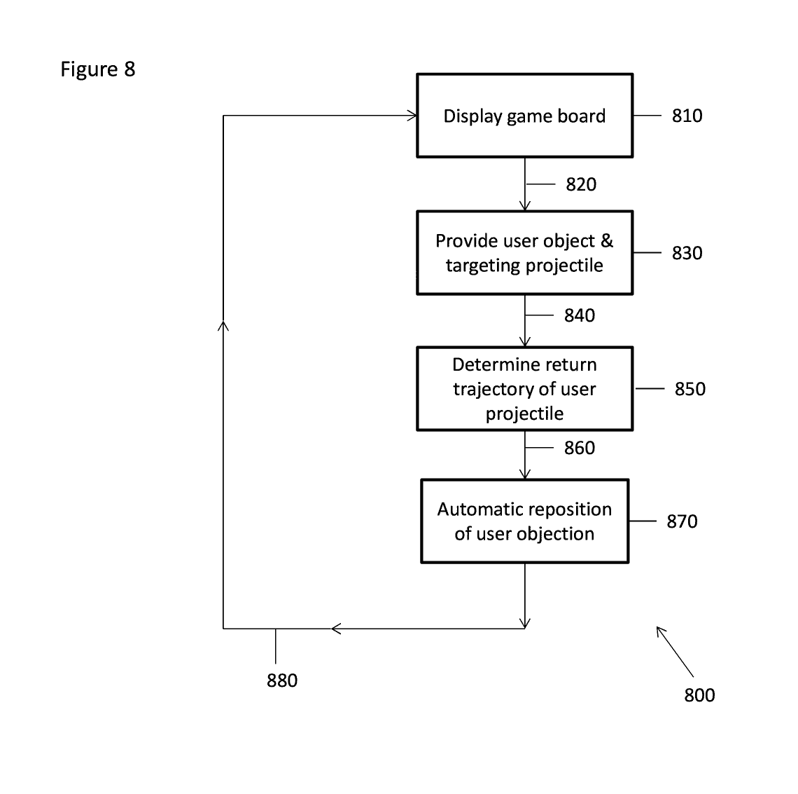

FIG. 8 is a flowchart 800 depicting steps of a computer implemented method implemented by the at least one processor 215 or server 320 in accordance with an embodiment.

Game area 110 is displayed at step 810 on the user device display 255 via said server 320 on the user interface 265, 255 of device 200. Program flow then flows via branch 820 to step 830 where the processor 215 provides for display a user object 130 and targeting projectile 140. In this step the targeting or aiming indicator 150 may be displayed. Selection of the targeting indicator 150 and manipulation by the user via the input means 265 device 200 may then be monitored and the release or shooting of projectile 140 detected.

Once the projectile has for example collided with a game object 120a, 120b, 120c, 120d area as shown and described with reference to FIG. 4c, the at least one processor may then determine a return trajectory of the user projectile 140 at step 850. Once the return trajectory 420 has been determined, flow proceeds via branch 860 to step 870 wherein the user object is automatically repositioned on the game area 110. Flow then returns via branch 880 to display the game board 100 at step 810.

Other steps may be included which are not shown in the diagram. For example, in some embodiments the detection of our collision of projectile 140 with a first game object 160 may cause generation of second or further game objects such as the aforementioned butterfly graphical representations on the game area.

The determination of the return trajectory may take into account such collisions, and take into account the elimination of game objects 120a, 120b, 120c, 120d.

Hence the angle of incidence and reflection of the projectile 140 when colliding with game objects 120a, 120b, 120c, 120d, first game objects 160, and/or second or further game objects 500a, 500b, 500c may be taken into account.

In another embodiment the angle of reflection, glancing angle may be randomly affected by the generation of a random or pseudorandom number. This may generate some unpredictability into the game, allowing for further ricochets and cascading bounces or collisions of the projectile 140 with objects 120a, 120b, 120c, 120d.

Other embodiments may comprise differing first and/or second or further game objects being graphically depicted.

In some embodiments the second or further game object 500 shares characteristics with the game objects 110b upon which it was created.

Subsequent selection 120a, 120b, 120c, 120d of the second or further game object 500, as indicated by selection indicator 120a, 120b, 120c, 120d in FIG. 5, may eliminate all matching game objects having the same characteristics as well as the second or further game object itself 500.

Hence a game mechanic which enables creation of first, second or further game objects to reach the target indicator 130 in skilful and engaging fashion is provided.

However, the creation of the first or second or further game object 500 may then accelerate the elimination of designated target game objects 130 to achieve the goal of the level. Such mechanics require predetermined rules and game behaviour technical considerations in order to finely balance the game and create an engaging game.

Some embodiments of the game allows for the game to be synchronised between different devices or platforms.

The game can for instance be played in an offline mode on a handheld device using locally stored information on the handheld device. The device can store all or some of the levels that are available for the player to play in the game. Some of the features in the game can be locally run on the device and dependent on the local machine. This can for instance be that if the game is implemented to regenerate lives after a certain period of time, then the time can be locally decided based on the clock on the device. In some embodiments, the central game server clock can override the local clock when the local device has been synchronised with the server.

A game can be implemented so that the player is informed if it has synchronised the available data with the central server or servers. This can for instance be through a coloured symbol or a check mark that indicates that the information is up to date.

The game can also indicate if it has been able to establish a connection with the central server for synchronisation or if for instance the network connection is down. That the device is offline can for instance be illustrated with a greyed out icon.

The game can be implemented to synchronize game state information and/or retrieve and connect to the social graph information and user profile of the player on a social network such as Facebook or Google+.

The game can also be implemented so that it is connected to a plurality of social networks. The user can be given the option to select what information that can be derived and shared with which social network.

One example of how the game can be connected to a social network is the Facebook™'s Open Graph API allows websites and applications to draw and share information about more objects than simply people, including photos, events, and pages, and their relationships between each other. This expands the social graph concept to more than just relationships between individuals and instead applies it to virtual non-human objects between individuals, as well. A game can typically share in-game events such as that a level has been completed, that a player has passed a friend in the game or beaten a friend's high score on a level. The game can also post event such as that a player has purchased objects in the game or received objects from other players of the game.

Those skilled in the art will recognise that game object behaviour and characteristics, first or second or further game object creation, and game object behaviour in relation to first or second or further game objects, may be stored in the at least one memory 220 of user device 200 or server 320 or system 300, and the judicial technical consideration of projectile and game object behaviour as described hereinabove may provide an engaging and rewarding experience to the user.

Furthermore, various methods have been described. It should be appreciated that these methods will be implemented in apparatus, where the apparatus is implemented by any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

It is also noted herein that while the above describes embodiments of the invention, there are several variations and modifications which may be made to the disclosed solution without departing from the scope of the present invention.

1. A computer implemented method of controlling a user interface responsive to user engagement with a displayed game board on said interface, the method comprising the following implemented by at least one processor of a computer device in communication with said interface and at least one memory:
displaying a game board having a plurality of game objects, each having at least one or more characteristics,
providing a user object configured to target and release a user projectile associated with said user object at said game objects in response to user input,
determining a return trajectory of said projectile once released, and
automatically repositioning said user object on the displayed game board in response to said determined return trajectory to associate said user object with the returning projectile.

2. A method according to claim 1, wherein the determination of said return trajectory is dependent on the detection of a collision of the projectile with at least one game object.

3. A method according to claim 1, wherein the determination of said return trajectory is dependent on the detection of more than one collision of the projectile with more than one game object.

4. A method according to claim 1 further comprising the generation and display of at least one first game object sharing at least one characteristic with one or more of the plurality of game objects.

5. A method according to claim 4, comprising the generation and display of a second game object sharing at least one characteristic with one or more of the plurality of game objects in response to at least one detected collision of said projectile with the at least one first game object.

6. A method according to claim 5, wherein detection of a collision of said projectile with said second game object eliminates those displayed game objects sharing the at least one characteristic of said second game object.

7. A method according to claim 6, wherein the determination of said return trajectory is dependent on the elimination of said displayed game objects.

8. A method according to claim 2, wherein the determination of said return trajectory is further modified in dependence on the angle of incidence of said projectile with respect to said game board upon detection of said collision of the projectile with the at least one game object.

9. A method according to claim 8, wherein the further modification of said return trajectory comprises determining an angle of reflection in dependence on the angle of incidence.

10. A method according to claim 9, wherein the angle of reflection is determined at least in part in proportion to the angle of incidence.

11. A method according to claim 10, wherein the angle of reflection is adjusted by a random number in proportion to the angle of incidence.

12. A method according to claim 11, wherein the determined return trajectory is further modified in dependence on said random number adjustment.

13. A device having a user interface configured to display a game board having a plurality of game objects, each game object having one or more characteristics stored in at least one memory, said user interface being configured to receive user input, and at least one processor in connection or communication with the at least one memory and the user interface and configured to:
display a game area having a plurality of game objects, each having at least one or more characteristics,
provide a user object configured to target and release a user projectile associated with said user object at said game objects in response to user input,
determine a return trajectory of said projectile once released, and
automatically reposition said user object on the displayed game board in response to said determined return trajectory to associate said user object with the returning projectile.

14. A device according to claim 13, wherein the at least one memory stores one or more characteristics of one or more game objects, first game objects and second game objects for generation and display by said processor.

15. A device according to claim 14, wherein the one or more characteristics comprise at least one of: displayed colour, object type, collision behaviour.

16. A device according to claim 15, wherein the at least one stored collision behaviour comprises eliminating game objects sharing the same at least one characteristic.

17. A program comprising program code instructions that, when executed by a processor, causes said processor to perform the following steps:
displaying a game board having a plurality of game objects, each having at least one or more characteristics,
providing a user object configured to target and release a user projectile associated with said user object at said game objects in response to user input,
determining a return trajectory of said projectile once released, and
automatically repositioning said user object on the displayed game board in response to said determined return trajectory to associate said user object with the returning projectile.

18. A computer readable storage device storing instructions that, when executed by a processor, causes said processor to perform the following steps:
displaying a game board or area having a plurality of game objects, each having at least one or more characteristics,
providing a user object configured to target and release a user projectile associated with said user object at said game objects in response to user input,
determining a return trajectory of said projectile once released, and
automatically repositioning said user object on the displayed game board in response to said determined return trajectory to associate said user object with the returning projectile.
